(19) United States
(12) Patent Application Publication
(10) Pub. No.: US 2009/0097704 A1
(43) Pub. Date: Apr. 16, 2009

(54) ON-CHIP CAMERA SYSTEM FOR MULTIPLE OBJECT TRACKING AND IDENTIFICATION

(75) Inventors: Laura Savidge, Sunnyvale, CA (US); Rick Baer, Los Altos, CA (US); Scott Smith, Saratoga, CA (US)

Correspondence Address: RatnerPrestia, P.O. BOX 980, VALLEY FORGE, PA, 19482, US

(73) Assignee: MICRON TECHNOLOGY, INC., Boise, ID (US)

(21) Appl. No.: 11/869,806

(22) Filed: Oct. 10, 2007

(51) Int. Cl. G06K 9/00; H04N 5/228

(52) U.S. Cl. 382/103; 348/222.1; 348/E05.031

(57) ABSTRACT

Apparatus and methods provide multiple object identification and tracking using an object recognition system, such as a camera system. One method of tracking multiple objects includes constructing a first set of objects in real time as a camera scans an image of a first frame row by row. A second set of objects is constructed concurrently in real time as the camera scans an image of a second frame row by row. The first and second sets of objects are stored separately in memory and the sets of objects are compared. Based on the comparison between the first frame (previous frame) and the second frame (current frame), a unique ID is assigned to an object in the second frame (current frame).

### FIELD OF THE INVENTION

The present invention relates generally to camera systems. More particularly, the present invention relates to on-chip camera systems for object tracking and identification.

### BACKGROUND OF THE INVENTION

Identifying and tracking multiple objects from an image in a camera system often uses a frame memory to store images captured by an image sensor. After an image is read from the image sensor, data is processed to identify objects within the image. The frame memory is used because typical image sensors do not support multiple object readout, thus making it difficult to selectively read a desired object within the image. Additionally, some pixels of a potential object might appear in multiple regions of interest (ROIs) and may be difficult to read out multiple times unless they are stored in memory. Because frame memory is also often difficult to integrate with an image sensor on the same silicon die, it would be advantageous to develop an image sensor with integrated capabilities for allowing readout of multiple regions of interest (ROIs) and multiple object identification and tracking while minimizing the need for frame memory. In addition to tracking objects and transmitting multiple ROI image data, it would be advantageous to integrate processing on the image sensor to store a list of identified objects and output only object feature characteristics rather than outputting image information for each frame. This may reduce output bandwidth requirements and power consumption of a camera system.

### BRIEF DESCRIPTION OF THE DRAWING

FIG. 1 is a plan view of an object region of interest (ROI) of an image sensor;

FIG. 2A is an example of a non-object according to embodiments of object identification;

FIG. 2B is another example of a non-object according to embodiments of object identification;

FIG. 2C is an example of an object according to embodiments of object identification;

FIG. 3 is an example of row-wise new object identification according to an embodiment;

FIG. 4 illustrates an example of multiple objects sharing row-edges with no borders;

FIG. 5 is an example of middle-of-object identification according to an embodiment;

FIG. 6A illustrates an example of multiple potential objects sharing columns with a single object;

FIG. 6B illustrates an example of multiple objects sharing columns with a single potential object;

FIG. 7 is an example of multiple object identification according to an embodiment;

FIG. 8 illustrates an example of multiple objects sharing horizontal row-edges;

FIG. 9A is an object list detailing object information according to an embodiment;

FIG. 9B is an example of two object lists according to an embodiment;

FIG. 10 is a flow chart for object identification during operation in accordance with an embodiment;

FIG. 11 is an example of a camera system for identifying and tracking objects in accordance with an embodiment;

FIG. 12 is an example of an output structure of video data according to an embodiment;

FIG. 13 illustrates an example of row-wise object readout of an image according to an embodiment;

FIG. 14 is an example of data output of the row-wise object readout shown in FIG. 13; and

FIG. 15 illustrates an example of frame timing for the collection of object statistics.

### DETAILED DESCRIPTION OF THE INVENTION

Apparatus and methods are described to provide multiple object identification and tracking using a camera system. One example of tracking multiple objects includes constructing a first set of object data in real time as a camera scans an image of a first frame row by row. A second set of object data is constructed in real time as the camera scans an image of a second frame row by row. The first frame and second frame correspond, respectively, to a previous frame and a current frame. The first and second sets of object data are stored separately in memory and compared to each other. Based on the comparison, unique IDs are assigned sequentially to objects in the current frame.

According to embodiments of the invention, example camera systems on chip for tracking multiple objects are provided. The camera system includes a pixel array of rows and columns for obtaining pixel data of first and second image frames, e.g., previous and current image frames. The camera system also includes a system controller for scanning the pixel array so the image frames may be scanned row by row. A two line buffer memory is provided for storing pixel data of adjacent rolling first and second rows of the image frame, and a processor determines object statistics based on pixel data stored in the two line buffer memory. Object statistics of previous and current image frames are stored in first and second look-up-tables and a tracker module identifies an object in the current frame based on object statistics of the current and previous image frames.

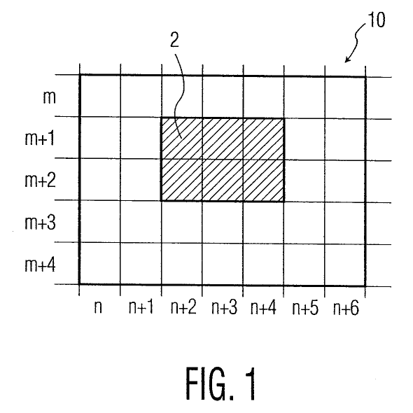

Referring now to FIG. 1, there is shown an image sensor pixel array 10 having an object 2 captured in an image frame. Tracking object 2 without need for a frame memory is accomplished (assuming that object 2 is distinct from the background) by identifying the position of object 2 and defining the object's region of interest (ROI), e.g., object boundaries. The region of interest is then used to define a readout window for pixel array 10. For example, if pixel array 10 has 1024×1024 pixels and object 2 is bounded by a 100×100 region, then a 100×100 pixel window may be read from pixel array 10, thus reducing the amount of image data that is stored or transmitted for object 2. As illustrated in FIG. 1, for example, object 2 is positionally bounded within pixel rows m+1 and m+2, and pixel columns n+2, n+3, and n+4 where m and n are integers. Thus, the region of interest and readout window of object 2 may be defined by [(m+2)−(m)]x[(n+4)−(n+1)] or 2×3 pixels.

In one embodiment, in order to simplify object identification and tracking, rules may be imposed to identify objects apart from non-objects. Non-objects, for example, may include background pixels or other images that may be distinguished from the foreground. In an embodiment, separation of objects from the background may be accomplished, for example, by a luminance threshold used to identify objects that are sufficiently reflective against a dark background. Alternatively, the chrominance of the object may be used in combination with its luminance to isolate object pixels from background pixels. In one example embodiment, rules may be used to identify objects from the background of an image regardless of object orientation or position in the image sensor pixel array.

An example of a rule for the identification of a potential object is the requirement that the object have a convex shape. Exclusion of concave shapes from object identification may prevent intrusion into a convex shaped body of an object by another object. It also may avoid the possibility of having background pixels in the convex shaped body of an object to be mistaken for two separate objects.

Another example of a rule for the identification of an object is setting pixel limits on the width of the convex object. The width of a convex object may be defined as the minimum pixel distance between two parallel lines tangent to opposite sides of the object's boundaries. A minimum object width may be used to avoid false positive identification of dust, hair, or image noise as objects. A rotationally symmetric constraint may also be used so that the potential object be of a minimum size before it is classified as an object.

Another object identification rule, for example, is limiting the velocity of the potential object between camera frames. Object velocity may be limited as a function of the camera frame rate to enable tracking of the object between a current and a previous frame. For example, a potential object in a previous frame that is missing in the current frame may be an anomaly because the object's velocity is faster than the camera frame rate.

Yet another example of an object identification rule is limiting the location of symbols, such as text, on the object. In an embodiment, any symbols on the object are enclosed within the object boundaries and are sufficiently separated from the edge of the object to minimize interference with the object's boundary. Referring to FIG. 1, for example, symbols may be included within the 2×3 pixel boundary of object 2, but may not touch the edges defining the boundary.

Another example of a rule is requiring that borders be printed on or near the edge of an object, thus allowing the image sensor to separate objects which have no background pixels between them. The use of border pixels may be useful in applications where objects are likely to touch, or when accuracy of object identification is especially important.

Although several object identification rules have been described, other rules may be implemented to improve object identification. For example, objects may be limited to one of several shape classes (e.g., circle, square, triangle, etc.). A maximum object size may also be imposed. A maximum object width may help to identify objects that have touching borders or boundaries. In another embodiment, an orientation parameter may be collected to determine the orientation of an object within a frame.

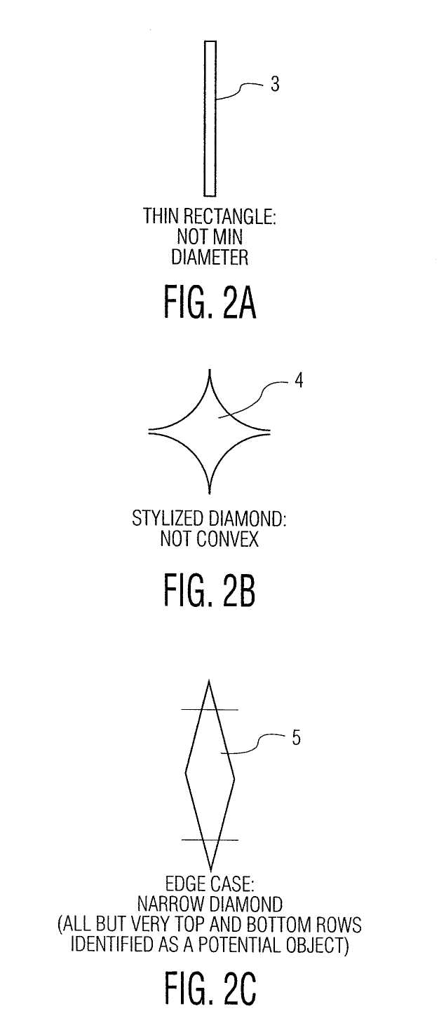

Referring now to FIGS. 2A-2C, examples of objects and non-objects are illustrated, according to the rules described above. As shown in FIG. 2A, a thin rectangle 3 has a pixel width that is less than a required minimum width necessary to classify rectangle 3 as an object. Accordingly, rectangle 3 is not classified as an object. As shown in FIG. 2B, a stylized diamond 4 fails to meet the convex object requirement and, therefore, is not identified as an object. As illustrated in FIG. 2C, convex diamond 5 has narrow, horizontal top and bottom edges that fail to meet a minimum width requirement. Thus, convex diamond 5 is identified as an object, except for the very top and bottom rows. As another example, a boundary region may be added to diamond 5, such that the top and bottom rows may still be included in the object image. Excluding these edge regions in shape statistics, however, may not significantly affect the resulting object identification.

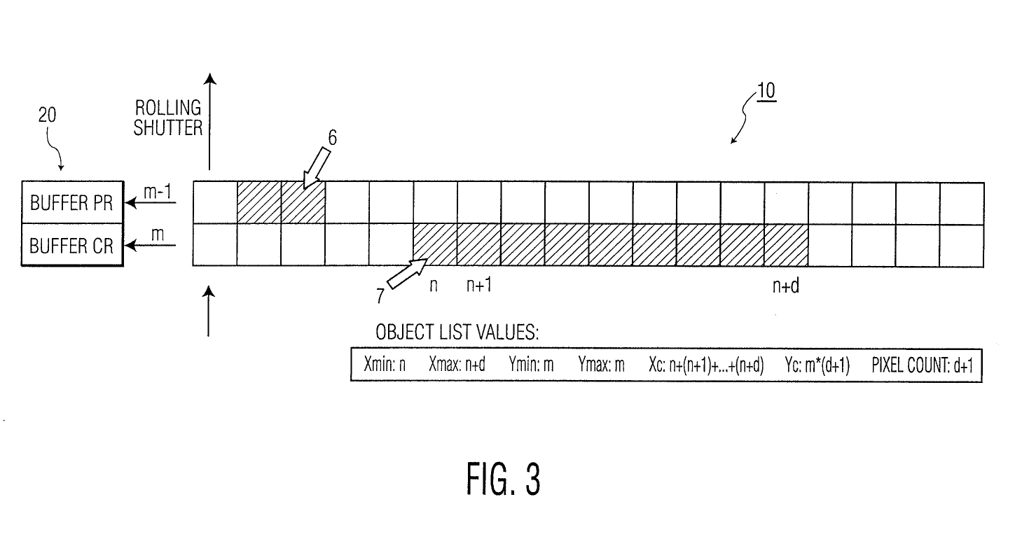

Referring now to FIG. 3, an example of identifying and tracking multiple objects in pixel array 10 is illustrated. As shown, objects are identified in pixel array 10 by a rolling shutter image sensor such as a system that samples one row at a time. Alternatively, objects may be identified in pixel array 10 of a full frame image sensor that samples each row in a rolling manner. In these embodiments, objects are identified using a two line buffer 20 including a current row (CR) buffer and a previous row (PR) buffer. Each current row (m) is compared to the previous row (m−1) in a rolling shutter process. As shown in FIG. 3, for example, object 6 in the previous row (m−1) is distinct from object 7 in the current row (m) since object 7 does not share or border any pixel columns with object 6. After a present row is processed, it is transferred from the CR buffer to the PR buffer, and the next row (m+1) is placed in the CR buffer. As a result, processing occurs using only two buffers—a PR buffer and a CR buffer, thereby minimizing usage of image frame memory.

As each row is processed in a rolling shutter, pixels are identified as belonging to either objects or background. As described above, object and background pixels may be distinguished by reflectance, chromaticity, or some other parameter. Strings of pixels forming potential objects in a current row (m) may be identified and compared to a previous row (m−1) to update properties of existing objects or identify new objects. For example, statistics for identified object 6, 7 may be determined on a row-by-row basis. Statistics for object data may include minimum and maximum object boundaries, e.g., row-wise and column-wise lengths, object centroid, shape parameters, orientation parameters, and length parameters of the object in the same row.

As illustrated in FIG. 3, for example, object 7 may be defined by a minimum column, Xmin (n^{th} column) and a maximum column, Xmax ((n+d)^{th} column), where n and d are positive integers. Object 7 may also be defined by a minimum row, Ymin (m^{th} row) and a maximum row, Ymax (m^{th} row), where m is a positive integer. In one embodiment, threshold values may be set for pixel intensity so that noise or bad pixels do not affect object identification. In another embodiment, any symbols or text printed on an object may be ignored when calculating object statistics.

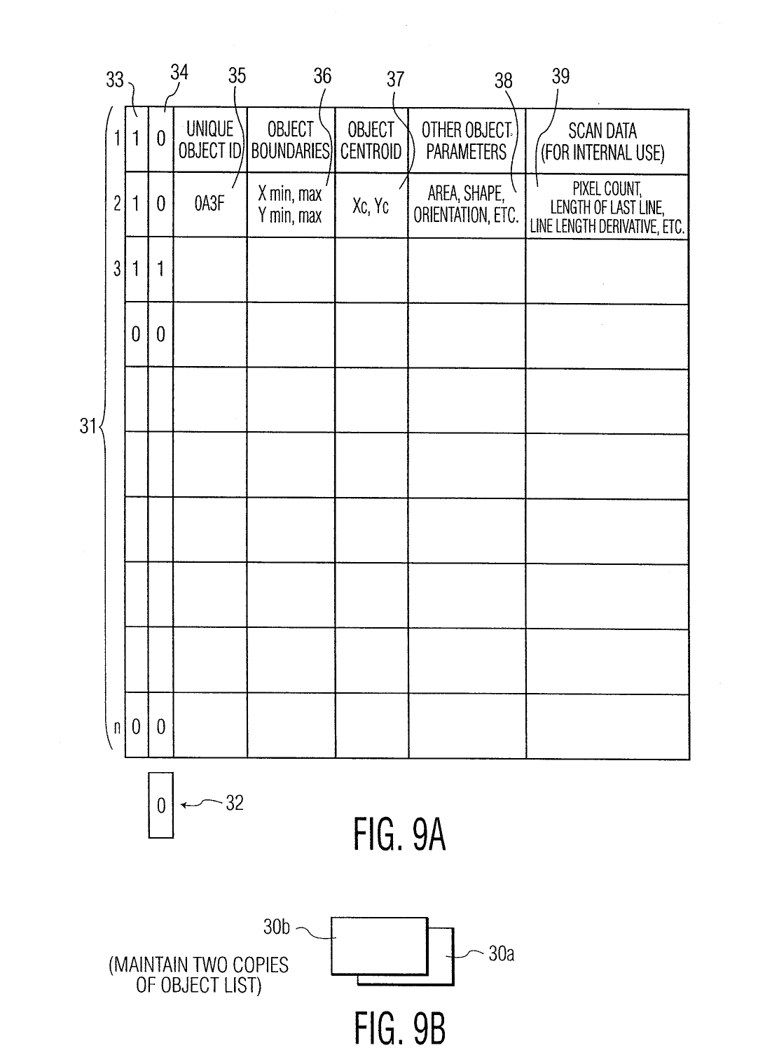

In an embodiment, the centroid or center of each object may be calculated. The centroid of object 7, for example, may be computed by determining the number of object pixels in the horizontal and vertical directions, e.g., Xc and Yc positions, respectively. As shown in FIG. 3, the horizontal center position Xc of object 7 is the summation of object pixels in the row-wise direction, and the vertical center position Yc is set to the number of object pixels multiplied by the row number. Of course, an object centroid cannot be calculated before all pixels of an object are identified, e.g., in all rows of an image. For these statistics, values are temporarily stored in an object list (FIG. 9A) and final calculations are performed when the entire frame has been processed. The centroid may then be computed using the following equations: Xc=Xc/pixel count and Yc=Yc/pixel count.

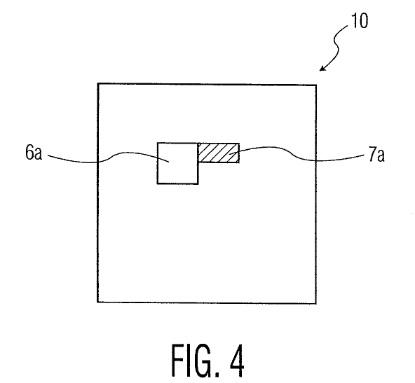

Referring now to FIG. 4, pixel array 10 with two objects 6a and 7a touching each other is illustrated. With touching objects in which both start on the same row, objects 6a and 7a may be identified as a single object. If one or both objects have borders, object 6a and 7a may be recognized as separate objects. The statistics for each object 6a, 7a may then be corrected accordingly. If objects 6a and 7a do not have borders, they may be treated as the same object an image frame. Information about the individual objects, however, may be discerned later by a person or a separate system and corrected.

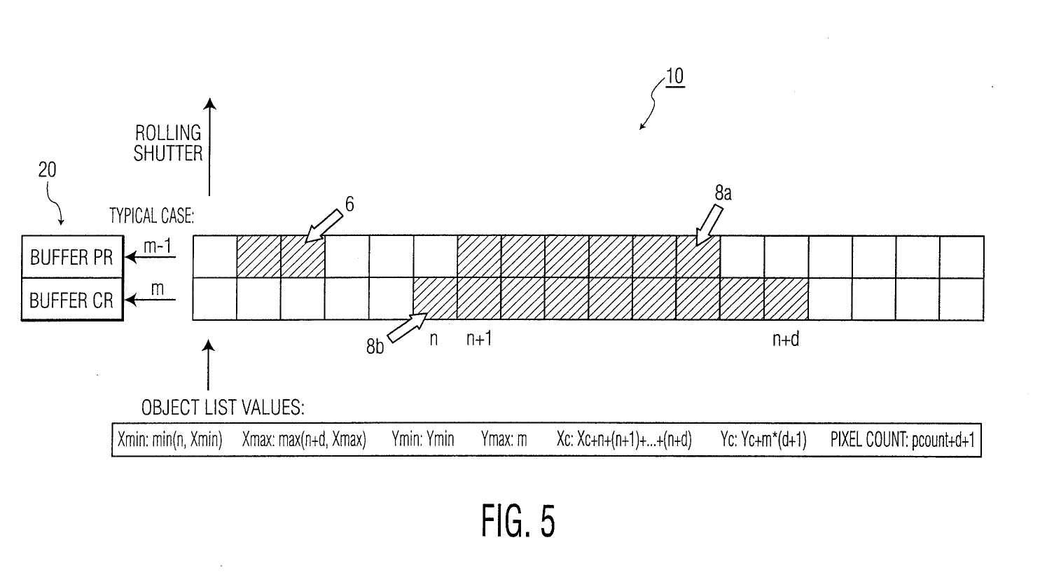

Referring now to FIG. 5, object continuity in two line buffer 20 is illustrated. Since object 8a in a previous row (m−1) shares columns with a potential object 8b in a current row (m), potential object 8b is identified as part of object 8a. This identification process may apply to many successive rows, as objects tend to span many rows.

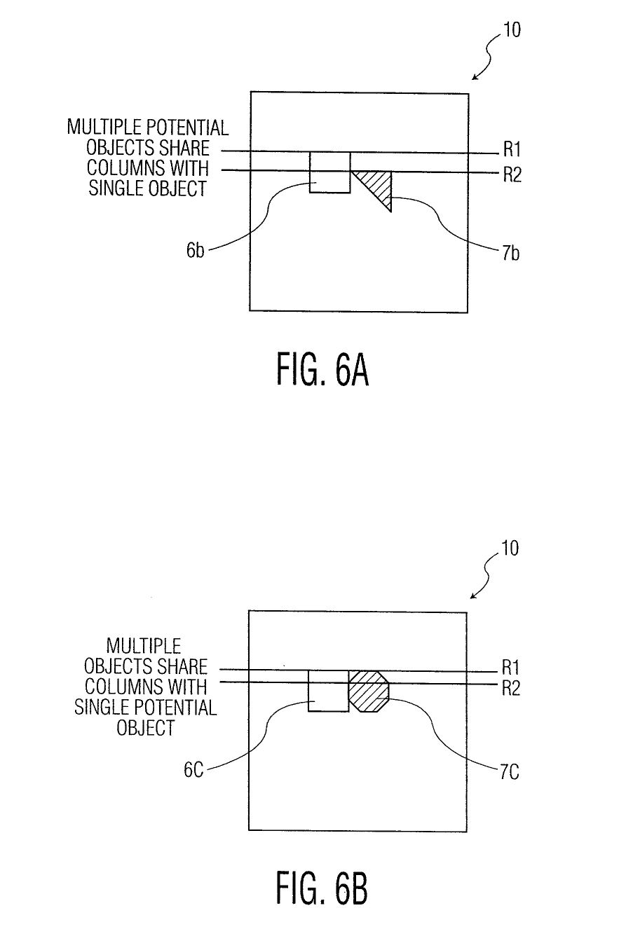

Referring next to FIGS. 6A and 6B, it may be observed that objects with adjacent column pixels in a middle row (R2) of pixel array 10 may result in different object identification scenarios. As shown in FIG. 6A, for example, during processing of row (R1), only one distinct object 6b is identified as an object. When row (R2) is processed, however, potential object 7b and object 6b have adjacent column pixels in at least one row. Thus, potential object 7b may be processed as either a distinct object that is separate from object 6b, or as a continuous object that is part of object 6b, e.g., a single object. In FIG. 6B, during processing of row (RI), two distinct objects 6c and 7c are identified. During processing of row (R2), however, objects 6c and 7c have adjacent column pixels in several rows. Accordingly, objects 6c and 7c may be processed as a single continuous object or as distinct objects.

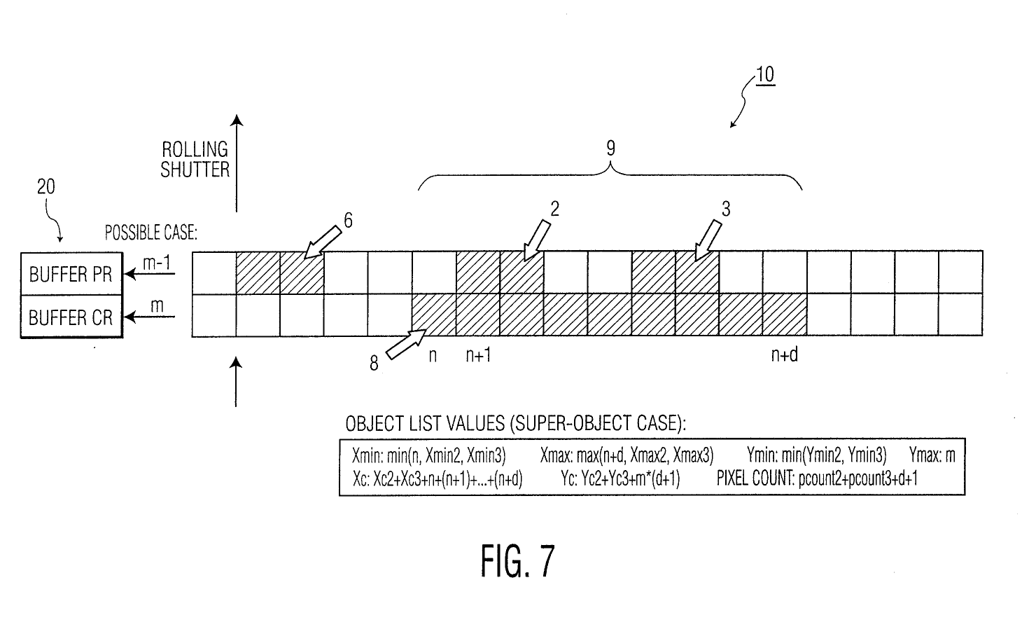

Referring now to FIG. 7, an example of a super-object 9 is illustrated. During scanning of a previous row (m−1), three distinct objects 6, 2, and 3 are initially identified. When the current row (m) is scanned and compared to the previous row (m−1), potential object 8 shares columns with objects 2 and 3. In this scenario, if border pixels are present, they may be used to identify which pixels belong to respective objects 2, 3, and 8. If no border pixels are present and objects 2, 3, and 8 cannot be separated, then they may be combined to form super-object 9. When combining multiple existing objects, the Xmin, Xmax, Ymin and Ymax boundaries of respective potential objects 2, 3, and 8 may be used for super-object 9. For example, Xmin and Ymin of super-object 9 may be computed as the minimum number of horizontal and vertical pixels, respectively, of potential objects 2, 3, and 8. Similarly, Xmax and Ymax of super-object 9 may be computed as the maximum number of horizontal and vertical pixels, respectively, of potential objects 2, 3, and 8. This ensures inclusion of all parts of objects 2, 3, and 8 in super-object 9. Additionally, Xc and Yc values may be summed so that the combined object centroid is correctly calculated. Other object parameters may be updated to combine potential objects 2, 3, and 8 into one distinct super-object 9.

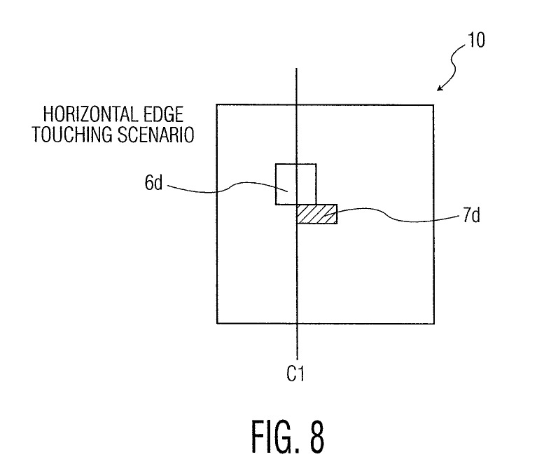

FIG. 8 illustrates another scenario of objects 6d and 7d having touching horizontal edges so that objects 6d and 7d share columns. In this scenario, object border pixels and memory of identified objects may be combined to better distinguish touching objects as either a single continuous object or as distinct objects. For example, the number of border pixels detected along column C1 of pixel array 10 may be stored. If one or more border pixels in column C1 are detected, the horizontal edge touching scenario may be identified. Thus, object 6d and 7d may be processed as separate and distinct objects, rather than a single continuous object. Of course, the amount of complexity included to detect different scenarios of touching objects may be modified to reflect an expected occurrence frequency of touching objects.

Referring now to FIGS. 9A and 9B, objects identified in pixel array 10 may be stored in two object lists 30a and 30b, corresponding to two look-up tables stored in an on-chip memory. For example, a first set of object data of a previous frame may be stored in first object list 30a, and a second set of object data for a current frame may be stored in second object list 30b. In one example shown in FIG. 9A, the first object list of a previous frame or the second object list of the current frame may be populated with rows of object index entries 31. Object index entries 31 may contain 1 to n entries that each corresponds to object data of a row so that the object list may be large enough to store data for an expected maximum number of objects found in a single frame. If the number of objects in a single frame exceeds the maximum number, a table overflow flag 32 may be tagged with “1” to indicate that the object list cannot record every object in the frame. Otherwise, table overflow flag 32 may be tagged with “0” to indicate that no object entry overflow exists.

Each, object list 30a or 30b may include a data validation bit column 33 that identifies each entry as “1” (e.g., true) or “0” (e.g., false) to indicate whether a particular entry contains valid object data. If an entry has valid object data, that entry is assigned a bit value of “1”, if an entry contains non-valid object data or empty data, it is assigned a bit value of “0”. As shown in FIG. 9A, the object list also includes a super-object identification column 34 that may be tagged with a respective true/false bit value to indicate whether an identified object contains data for two or more objects, e.g., a super-object.

In another embodiment, object statistics 36, 37, and 38 may be collected on a row by row basis during the object list construction using the two buffers described earlier. Object statistics may include object boundaries 36, object centroid 37, and other desired object parameters 38 such as area, shape, orientation, etc. of an object. The object list may also include scan data 39 for temporarily storing data that may be used internally for statistic calculation. For example, the number of pixels comprising an object may be recorded to calculate the object's centroid, e.g., the center of the object. Scan data 39 can also be used to better identify objects. For example, storing the object's longest row width may help to distinguish touching objects. By collecting and comparing limited statistics on objects between a current frame and a previous frame instead of using full images or other extensive information, the need for on-chip memory is advantageously minimized and the amount of data that needs to be communicated to a person is also minimized.

After object statistics are collected for an entire frame, each object within the current object list is assigned a unique ID 35 to facilitate object tracking between the previous image frame and the current image frame. As shown in FIG. 9B, two object lists 30a and 30b are stored in an on-chip memory to track objects between two successive image frames. Object list 30a is populated with data for the previous image frame, while object list 30b holds data for the current frame. An object that has not significantly changed shape and/or has moved less than a set amount between frames may be identified with the same unique ID in both object lists 30a and 30b. Thus, storing object data for two successive frames allows object tracking from one frame to the next frame while minimizing the need for a full frame buffer. Additionally, using unique IDs 35 in addition to object list index 31 provides for listing many object ID numbers while reusing entry rows. In addition, using unique IDs allows object statistics to be collected during the construction of object list 30a or 30b and separates the construction process from the object tracking process, as explained below.

After object statistics have been collected, current frame object list 30b and previous frame object list 30a are compared to track objects between the two frames. Each row of the current frame object list is compared to the same row of the previous frame list in order to identify similarities. For example, based on the comparison, rows having their centroid, object boundaries, and other shape parameters within a set threshold of each other are identified as the same object and also give the same object ID 35 from the previous frame list. If no objects of a row from the previous frame list have matching statistics to a row of the current frame list, a new object ID 35 is assigned that does not match any already used in the current object list or in the previous object list. According to another embodiment, temporary IDs of the current object list may be assigned unique IDs from the previous object list after comparing the two lists.

After all rows that are marked valid in current image frame 30b have been assigned the appropriate object IDs, current frame object list 30b is copied to the previous frame object list 30a. All valid bits of current frame object list 30b are then initialized to 0 and the list is ready for statistical collection of a new frame (the new current frame).

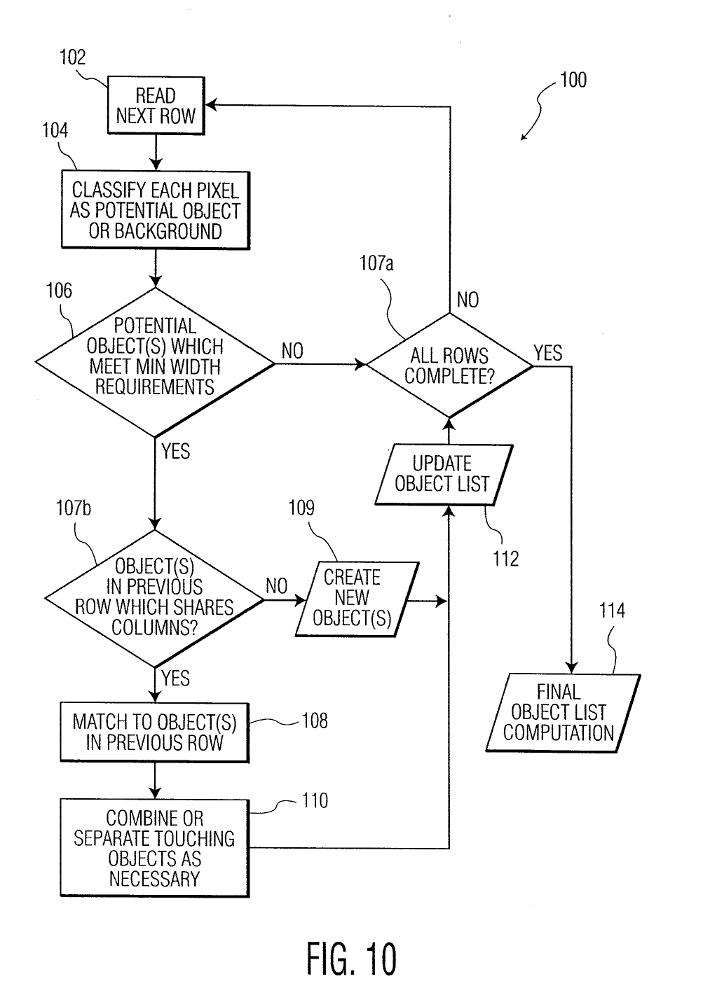

Referring now to FIG. 10, flow chart 100 illustrates example steps for identifying objects and constructing the object list on a row-by-row basis. The steps will be described with reference to FIGS. 1-9.

In operation, at step 102, a row from a field of view of image frame 10, is scanned and sampled. The row being sampled is a current row having its column pixels read into the CR buffer (which is one of the two line frame buffer memory 20).

At step 104, each pixel within the current row (m) is classified as part of a potential object 7, 8, 8b or as part of the background. A luminance threshold may be used to identify objects 7, 8, or 8b that are sufficiently reflective against a dark background. Alternatively, the chrominance of object 7, 8, or 8b may be used in combination with the luminance values to isolate object pixels from background pixels.

At step 106, a logic statement determines whether identified potential objects 7, 8, or 8b in current row (m) meets a minimum width requirement. For example, the minimum width requirement may be satisfied, if the number of object pixels in the current row (m) meets or exceeds a minimum pixel string length.

If potential object 7, 8, or 8b does not meet the minimum width requirement, potential object 7, 8, or 8b is not classified as an object and operation proceeds to step 107a. At step 107a, a logic statement determines whether all rows in pixel array 10 have been scanned. If all rows have not been scanned, the method continues scanning of rows in pixel array 10.

Referring to step 107b, if potential object 7, 8, or 8b meets the minimum width requirement, a logic statement determines whether an identified object 6, 8a, 2, or 3 in a previous row (m−1) of two line frame buffer memory 20 shares pixel columns with potential object 7, 8, or 8b in the current row (m). If pixel columns are shared, (e.g., contiguous), object data of the current row and object data of the previous row are determined to belong to the same object. At step 108, potential object 7, 8, or 8b in the current row is matched to object 6, 8a, 2, or 3 in the previous row. At step 110, matched objects 2, 3, 8a, or 8b may be combined as super-object 9 or separated as distinct objects. As another example, at step 109, if pixel columns are not shared, (e.g., not contiguous), object data of the current row and object data of the previous row are determined to belong to different objects, and a new distinct object may be constructed in that row. At step 112, the current object list 30b is updated with statistics for each identified object.

After all rows in pixel array 10 have been scanned, operation proceeds to step 114 in which the current object list 30b for the current frame is finalized. If all rows have not been scanned, the operation repeats until all rows have been scanned, sampled, and tabularized in current object list 30b. As described earlier, the unique ID 35 is not yet tabularized because it requires comparison to the previous object list 30a.

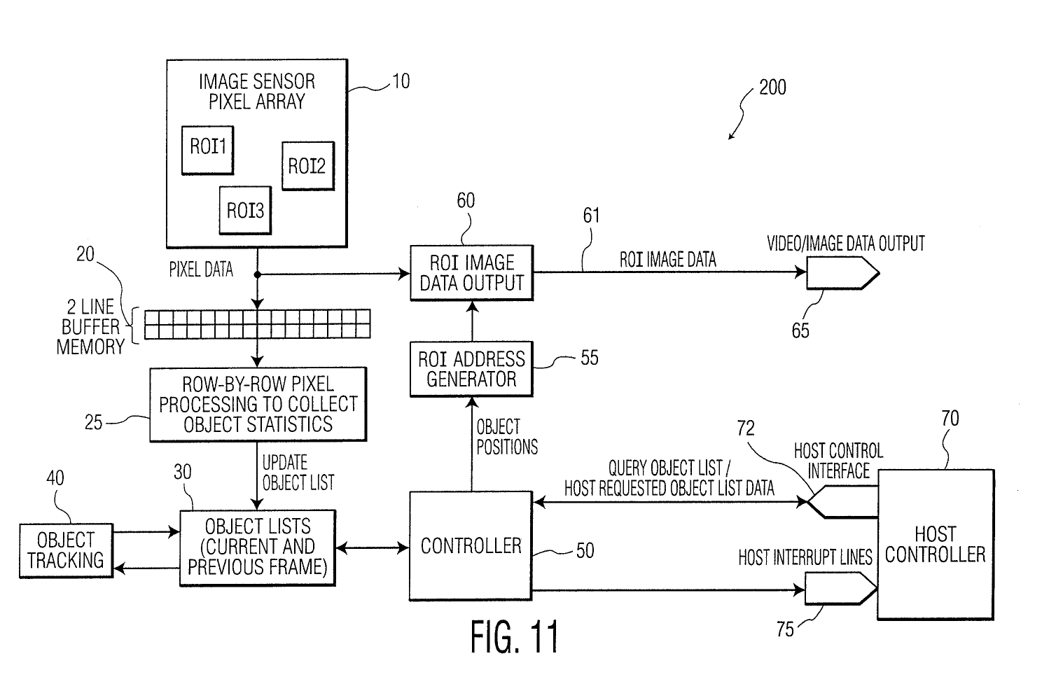

Referring now to FIG. 11, camera system 200 is provided to track multiple objects. The camera system 200 includes pixel array 10 having rows and columns of pixel data. Pixel data is collected for a current image frame and a previous image frame. Pixel data is stored in a two line buffer memory 20 which stores a current row and a previous row of a frame. The data keeps moving through the two line buffer in a rolling shutter row-by-row, until all rows have been sampled.

Camera system 200 also includes processor 25 which processes each pixel row by row and determines object statistics based on the pixel data stored in the two line buffer memory 20. For example, processor 25 may be configured to determine at least one object statistic such as minimum and maximum object boundaries, object centroid, shape, orientation, and/or length of an object in a current row or a previous row, both having been temporarily stored in the processor 25. As another example, processor 25 may be configured to determine whether a potential object in a current row is or is not contiguous to pixel data in a previous row. Processor 25 may also determine whether to combine objects into super-objects or separate objects into distinct objects.

As another example, processor 25 may determine objects in a row based on light intensity of one or more pixels in that row. The light intensity may have threshold values representing different chromaticity and/or different luminance values to distinguish object pixels from background pixels. Moreover, two objects may be identified in a row based on a first set of contiguous pixels and a second set of contiguous pixels having different chromaticity and/or different luminance values. When the first and second sets are not contiguous to each other, they may each represent a distinct object. In another embodiment, objects may be determined in a row, based on light intensities of consecutive pixels exceeding a threshold value belonging to a convex pattern of intensities.

As shown, camera system 200 also includes two object lists 30, e.g., look up tables, stored in memory. The two object lists represent objects in the current and previous image frames. The current image frame is compared to the previous image frame by object tracker 40. For example, object list 30a is a first look up table that includes multiple objects identified by unique IDs based on object statistics of a previous frame. Another object list, object list 30b is a second look up table that includes multiple objects identified by temporary IDs based on object statistics on a row-by-row basis of the current frame. The temporary IDs are assigned unique IDs by tracker 40 after a comparison of object lists 30a and 30b. Processor 25 is configured to replace object statistics of previous object list 30a with object statistics in current object list 30b after assigning unique IDs to the objects in current object list 30b. Current object list is now emptied and readied for the next frame. Thus, objects may be tracked between sequential image frames.

According to another embodiment, camera system 200 may include system controller 50 coupled to an external host controller 70. An example external host controller 70 has an interface 72 which may be utilized by a user to request one or more objects (ROIs) identified in the two object lists 30. For example, an image of an object (ROI) may be provided to host controller 70 based on the unique ID assigned to that object. System controller 50 is configured to access object lists 30a and 30b and transmit the object (ROI) requested by host controller 70. System controller 50 may scan pixel array 10 so that current and previous image frames are sampled row by row to form object lists 30. Only objects (ROIs) requested by host controller 70 are transmitted. For example, if host controller 70 requests two unique IDs assigned to two respective objects, images of the two objects are transmitted to host controller 70. Interrupt lines 75 may be used to request the host's attention, when a significant change occurred, as detected by way of object lists 30. Examples of such changes include object motion and the addition or removal of an object from object lists 30.

In another example embodiment, host controller 70 may request a region of interest (ROI) image. In response, an example system controller 50 accesses stored object lists 30 and transmits an ROI position to ROI address generator 55. Address generator 55 converts the object position into an address of the requested (ROI) on the frame. The selected data of the ROI is combined with header information and packetized into data output 60. ROI image data 61 is output to a user by way of video output interface 65. As an example, image data 61 may be output from video output interface 65 during the next image frame readout. It is assumed that the objects are not too close to each other, so that the size of the ROI (min/max x and y+ROI boundary pixels) may be unambiguously determined by from the object list statistics. Image data for additional objects may also be requested by the host and output in subsequent frames.

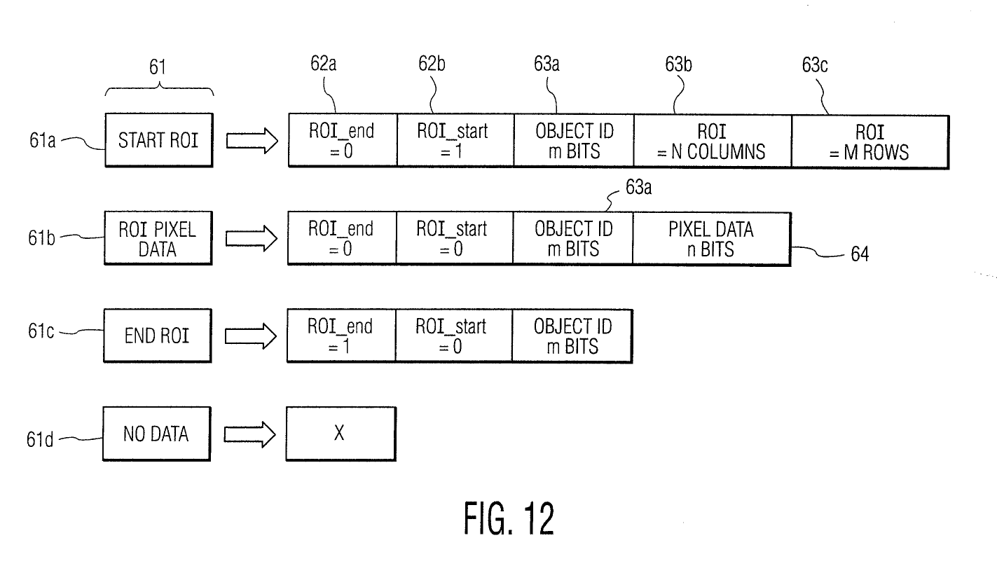

Referring now to FIG. 12, image data 61 is packetized by including an end ROI bit 62a and a start ROI bit 62b to indicate, respectively, the end or the beginning of an ROI. As shown, packet 61 also includes the object ID 63a to identify the ROI. For the start ROI packet 61a, the size of the region in terms of columns 63b and rows 63c is transmitted so a user/host. The ROI pixel data packet 61b includes object ID 63a and pixel data 64. For an end ROI packet, end ROI bit 62a is assigned a value of “1”, to indicate the end of the ROI. Data packet 61d denotes data that does not belong to the ROI packet.

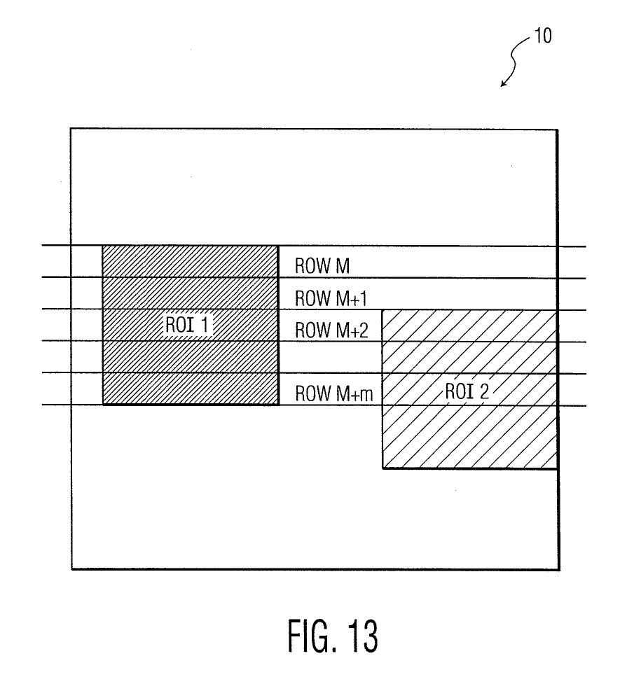

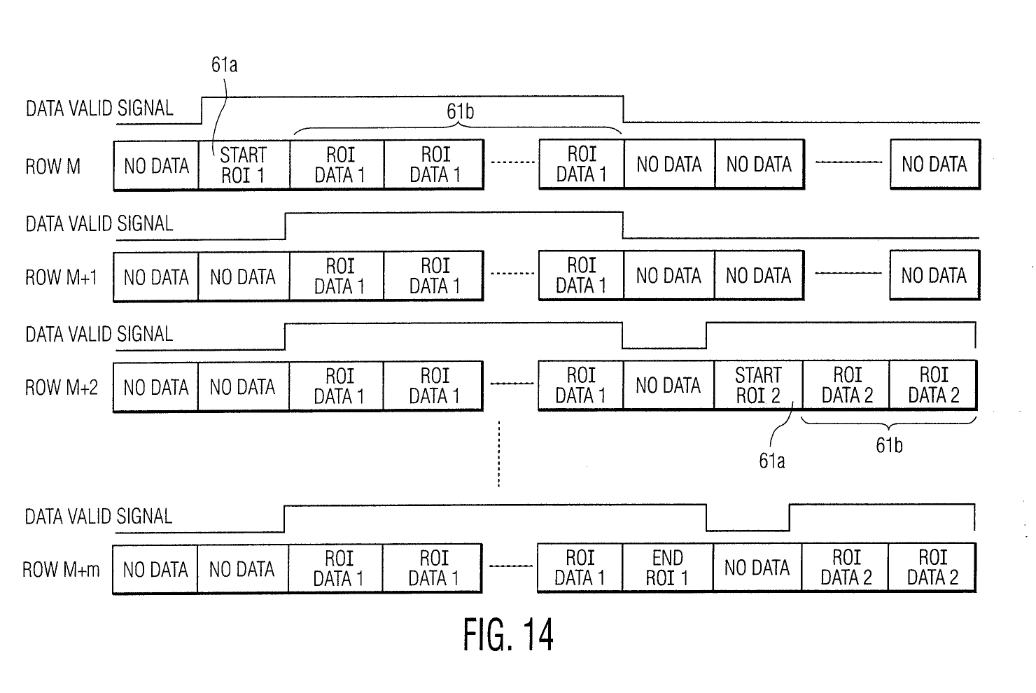

Referring now to FIGS. 13 and 14, readout of pixel array 10 using the above described data packet structure is illustrated using a rolling shutter row-by-row process. As shown in FIG. 13, ROI regions ROI1 and ROI2 each include contiguous pixels, which are also separated by a discontinuity, e.g., background pixels. Pixel array 10, for example, is scanned along rows M, M+1, M+2, to M+m. As shown in FIG. 14, a start ROI1 packet 61 a is sent, followed by multiple pixel data packets 61b for the pixels of ROI1 in row M. The data valid signal is set true, e.g., “1” for start ROI1 61a and data packets 61b. The data valid is set false, e.g., “0” for columns that do not belong to ROI1. Multiple pixel data packets are contained in row M+1, as shown. Note that the packets do not include a start ROI bit. Similarly, the packets are continued in row M+2. When ROI2 is reached in row M+2, a start ROI2 packet 61a is sent, followed by ROI2 data packets 61b. Since respective packets 61a includes the ROI object ID, the host controller may reconstruct each ROI image, even though data of multiple ROIs are interleaved row by row. Upon reaching the last row of an ROI, an end ROI packet (61c, FIG. 12) is sent, thereby signaling that the last pixel for the respective ROI has been sent.

In another embodiment, the occurrence of overlapping ROIs, e.g., a super-object, the ROI pixel data packet structure may be modified to tag the data with additional object IDs (63a, FIG. 12). Accordingly, pixel data belonging to multiple ROIs may be identified. ROI image readout may also be limited to only new or selected objects. This may reduce the amount of data that is sent to the host controller.

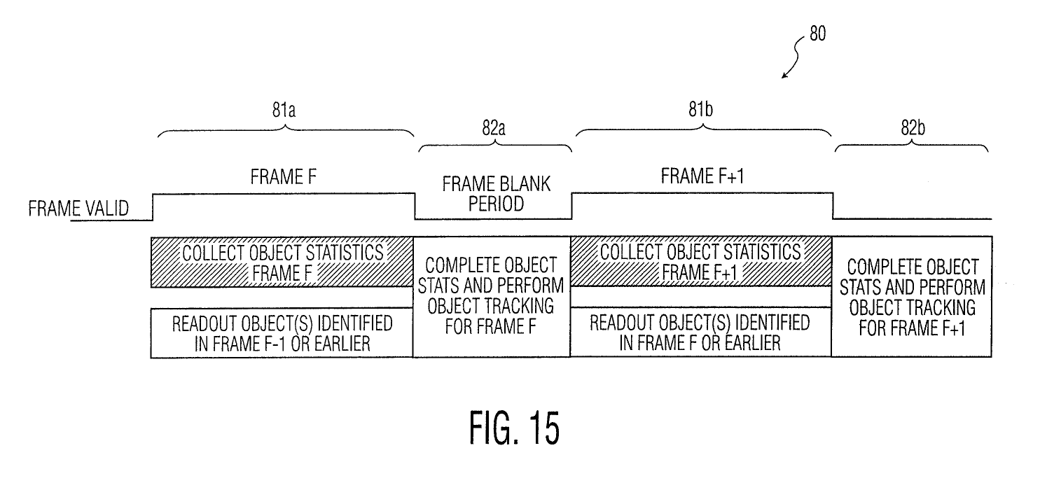

Referring now to FIG. 15, frame timing 80 showing a collection of object statistics and object list construction are illustrated. According to the embodiment shown, a full object list 30 is constructed during the frame blanking periods 82a and 82b. The computational requirements to build object lists 30a or 30b are small compared to frame blanking periods 81a and 82b. This allows object list construction during real time. According to another embodiment, time latency may occur between the time an object position is detected and when ROI image data is first read. If the host requires additional time to read and process the object list data, this time latency may also be used for completing the object list.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A method of tracking multiple objects using an image capture device comprising:
constructing a first set of objects as the image capture device is scanning row by row an image of a previous frame;
constructing a second set of objects as the image capture device is scanning row by row an image of a current frame;
comparing the second set of objects to the first set of objects; and
assigning, sequentially, in the current frame, a unique identification (ID) to an object, based on the comparing step.

2. The method of claim 1 wherein
the comparing step includes matching an object in a row of the previous frame to an object in a corresponding row of the current frame, and
the assigning step includes assigning the unique ID of the object in the previous frame to the object in the current frame.

3. The method of claim 1 wherein
the constructing of the second set of objects includes collecting at least two of the following items:
(a) a first object boundary indicating a minimum column belonging to an object in a row,
(b) a second object boundary indicating a maximum column belonging to the object in the corresponding row, and
(c) an object centroid indicating a center of the object in the corresponding row.

4. The method of claim 3 wherein
the constructing further includes collecting at least one of the following items:
(d) a shape parameter of the object in the corresponding row,
(e) an orientation parameter of the object in the corresponding row, and
(f) a length parameter of a previous row of the current frame.

5. The method of claim 3 wherein the constructing step includes comparing the collected items belonging to the object in the row to collected items belonging to another object in a previous row of the current image, and determining that the object of the row corresponds to the other object of the previous row, when the collected items are substantially similar between the row and the previous row.

6. The method of claim 3 wherein the constructing step further includes
comparing the collected items belonging to the object in the row to collected items belonging to another object in a previous row of the current image, and
determining that the object of the row is different from the other object of the previous row, when the collected items are substantially dissimilar between the row and the previous row.

7. The method of claim 1 wherein
storing the first set of objects includes storing data of the first set of objects in a first table, and
storing the second set of objects includes storing data of the second set of objects in a second table.

8. The method of claim 7 wherein
the steps of storing include replacing data in the first table with data in the second table, and
the steps of constructing include constructing another second set of objects as the image capture device is scanning row by row an image of a subsequent frame.

9. The method of claim 1 wherein
the step of constructing a second set of objects includes determining if an object in a current row is contiguous to an object in a previous row, and
determining that the object of the current row and the object of the previous row belong to the same object, if the objects are contiguous, and
determining that the object of the current row and the object of the previous row belong to two different objects, if the objects are not contiguous.

10. The method of claim 1 further including
providing an image of an object stored in memory to an external host computer, based on the unique ID assigned to the object.

11. A method of providing an image of an object, stored in an image capture device, to an external host controller, comprising:
scanning row by row, a field of view of a first image, to collect image data for the first image;
scanning row by row, a field of view of a second image, to collect image data for the second image;
comparing the first image data with the second image data,
determining a plurality of objects in the second image, based on the comparison step;
assigning a unique ID to each object determined in the determining step; and
providing an image of an object to the host controller, based on the unique ID assigned to the object, wherein
scanning the field of view of the first and second images includes:
processing adjacent rows of the image using a two-line buffer memory, and
forming an object list by comparing only the adjacent rows of the image.

12. The method of claim 11 including
determining another plurality of objects in the first frame;
storing the other plurality of objects of the first frame in a first table;
storing the plurality of objects in the second frame in a second table; and
assigning the same unique ID to each object in the second table, if the respective object matches a unique ID assigned to an object in the first table; and
replacing the first table with the second table.

13. The method of claim 11 including the steps of:
sending, by the host controller, the unique ID assigned to the object; and
transmitting, by the image capture device, the image of the object to the host controller, in response to the unique ID requested by the host controller.

14. The method of claim 11 wherein providing the image includes
providing an image of at least two objects to the host controller, when the host controller requests at least two unique IDs assigned to two respective objects.

15. The method of claim 11 wherein the step of providing the image of the object to the host controller includes the step of:
transmitting a packet of data including an identifier for a starting pixel of the object, an identifier for an ending pixel of the object, numbers of columns and rows of the object, and data pixels of the object.

16. A camera system on chip for tracking multiple objects comprising:
a pixel array of rows and columns for obtaining pixel data of a first image frame and a second image frame,
a system controller for executing a row-by-row scan of the pixel array, so that data is collected for the first and second image frames,
a two line buffer memory for storing pixel data of adjacent rolling first and second rows of the first and second image frames,
a processor for determining object statistics based on the pixel data stored in the two line buffer memory,
a first look up table stored in a memory including object statistics of the first image frame,
a second look up table stored in the memory including object statistics of the second image frame, and
a tracker module for identifying an object in the second frame based on the object statistics of the second image frame and the first image frame.

17. The camera system on chip of claim 16 wherein
the processor is configured to determine at least two of the following statistics:
(a) a first object boundary indicating a minimum column belonging to an object in a row,
(b) a second object boundary indicating a maximum column belonging to the object in the same row, and
(c) an object centroid indicating a center of the object in the same row,
(d) a shape parameter of the object in the same row,
(e) an orientation parameter of the object in the same row, and
(f) a length parameter of a previous row.

18. The camera system on chip of claim 16 wherein
the processor is configured to determine that one object is present in the two line buffer memory, if pixel data in the second row is contiguous to pixel data in the first row, and
the processor is configured to determine that at least two objects are present in the two line buffer memory, if pixel data in the second row is not contiguous to pixel data in the first row.

19. The camera system on chip of claim 16 wherein
the first look up table includes multiple objects identified by unique IDs based on the object statistics of the first image frame,
the second look up table includes multiple objects identified by temporary IDs based on the object statistics of the second image frame, and
the temporary IDs are assigned unique IDs after a comparison of the second look up table with the first look up table.

20. The camera system on chip of claim 19 wherein
the processor is configured to replace the object statistics in the first look up table with the object statistics in the second look up table, after assigning the unique IDs in the second look up table.

21. The camera system on chip of claim 16 wherein
each row of the first look up table includes an object of the first image frame, and
each row of the second look up table includes an object of the second image frame.

22. The camera system on chip of claim 21 wherein
the processor is configured to determine an object in a row based on intensity of at least one pixel in the row exceeding a threshold value.

23. The camera system on chip of claim 21 wherein
the processor is configured to determine an object in a row based on intensities of multiple consecutive pixels in the row exceeding a threshold value.

24. The camera system on chip of claim 21 wherein
the processor is configured to determine an object in a row based on intensities of multiple pixels in the row having a convex pattern of intensities.

25. The camera system on chip of claim 21 wherein
the processor is configured to determine at least two objects in a row, based on a first set of contiguous pixels in the row exceeding a threshold value and a second set of contiguous pixels in the row exceeding the threshold value, and the first set and the second set are not contiguous to each other.

26. The camera system on chip of claim 16 including
an external host controller coupled to the system controller for requesting an object identified in the second image frame, wherein
the system controller is configured to transmit the object requested by the host controller.

27. The camera system on chip of claim 26 wherein
the system controller is configured to transmit only the object requested by the host controller.
